(19) United States
(12) Patent Application Publication
(10) Pub. No.: US 2008/0101754 A1
(43) Pub. Date: May 1, 2008

(54) Optical waveguide

(76) Inventors: Michael Charles Parker, Colchester (GB); Makiko Hisatomi, Kesgrave (GB); Stuart Douglas Walker, Colchester (GB)

Correspondence Address: BAKER BOTTS L.L.P., 2001 ROSS AVENUE, SUITE 600, DALLAS, TX, 75201-2980, US

(21) Appl. No.: 10/570,696

(22) Filed: Mar. 3, 2006

(30) Foreign Application Priority Data
Mar. 4, 2005 (EP) 05251330.6

(51) Int. Cl. G02B 6/028

(52) U.S. Cl. 385/124

(57) ABSTRACT

An optical waveguide comprises a core and is characterised in that the core has a refractive index that includes a radial discontinuity and varies, with increasing azimuthal angle θ, from a first value n₂ at a first side of the discontinuity to a second value n₁ at a second side of the discontinuity.

### TECHNICAL FIELD OF THE INVENTION

The present invention relates to the field of optical waveguides, including optical fibres.

### BACKGROUND OF THE INVENTION

Optical fibres are typically very long strands of glass, plastic or other suitable material. In cross-section, an optical fibre typically comprises a central core region surrounded by an annular cladding, which in turn is often surrounded by an annular jacket that protects the fibre from mechanical damage. Light is guided in the fibre by virtue of a difference in refractive index between the core and the cladding: the cladding is of a lower refractive index than the core and so light introduced into the core can be confined there by total internal reflection at the core-cladding boundary.

Many variants of optical waveguide are known. For example, some fibres have a cladding that comprises far more complicated pattern of steps in refractive index or a cladding that has a refractive index profile that varies smoothly from the core in some manner. Some fibres each have more than one core.

The different refractive indices of the core and cladding usually result from a difference in the concentration of dopants between those parts of the fibre; however, in some fibres, the different refractive indices result from different distributions of holes in the cladding and the core. Such fibres are examples of a class of waveguides often called “microstructured fibres”, “holey fibres” or “photonic crystal fibres”. In some cases, guidance of light in the fibre does not result from total internal reflection but from another mechanism such as the existence of a photonic band gap resulting from the distribution of holes in the cladding.

Other examples of microstructured fibres include fibres having cladding regions comprising concentric (solid) regions of differing refractive index.

Recently, there has been interest in the properties of light with orbital angular momentum (OAM). OAM can be considered to be a higher-order form of circular polarisation, since circular polarisation comes in only 2 varieties: left- and right-handed polarisation, valued at either ± h̅, where h̅=h/2π, and h is the Planck constant. Light with OAM still has a circular symmetry, but can be valued at integer multiples of h̅, such that it is either ±l h̅, where l is an integer. In addition, there has been speculation regarding the possibility of waveguiding such ‘twisted light’ so that the OAM is preserved within the waveguide.

In addition, the study of singular optics has been the subject of increasing scientific interest, resulting in recent descriptions of the production of high orbital angular momentum (OAM) photons, which may be used as optical tweezers, or in cryptographic data transmission.

### SUMMARY OF THE INVENTION

Particular embodiments of the present invention provide a chiral waveguide that supports propagation of light with orbital angular momentum |l|≧1 of one handedness but does not support propagation of light of the opposite handedness.

According to a first aspect of the invention, there is provided an optical waveguide comprising a core characterised in that the core has a refractive index that includes a radial discontinuity and varies, with increasing azimuthal angle θ, from a first value n₂ at a first side of the discontinuity to a second value n₁ at a second side of the discontinuity.

A discontinuity in refractive index is a region at which the refractive index changes over a very short distance from a relatively high value n₂ to a relatively low value n₁: theoretically, it would be an infinitely steep change between the two values but of course in practice the change occurs over a finite distance.

A radial discontinuity is a discontinuity that extends in the direction of a radius from the centre (or substantially the centre) of the core. The radial discontinuity may start at the centre of the core or it may start away from the centre of the core, at another point on a radius.

The azimuthal angle θ is the angle between the radial discontinuity (or any chosen radial discontinuity, if there is more than one) and another radial direction.

The variation in refractive index may be taken to be a variation in the local refractive index at points in the core or, in the case of a waveguide having a holey or similarly microstructured core, it may be taken to be a variation in the effective refractive index at points in the core (the effective refractive index being the refractive index resulting from the net effect of local microstructure).

The variation in refractive index may be monotonic (increasing or decreasing) with azimuthal angle, over 360 degrees, from the first value n₂ to the second value n₁. The variation may be linear (increasing or decreasing) with azimuthal angle, over 360 degrees, from the first value n₂ to the second value n₁.

The waveguide may be an optical fibre. The waveguide may comprise a cladding, surrounding the core. The cladding may have a refractive index n₃ that is less than n₁ and n₂. Alternatively, the cladding may have a refractive index n₃ that is greater than n₁ and n₂. The discontinuity may reach the cladding or may stop short of the cladding.

Due to the refractive-index variation within the core, light may follow a left- or right-handed spiral as it propagates along the length of the waveguide.

The waveguide may further comprise a region into which the discontinuity does not extend, which is at (or substantially at) the centre of the core. The region may be a cylinder. The cylinder may be concentric with the core. The cylinder may be concentric with the waveguide. The region may have a refractive index of, for example, n₁, n₂, n₃, or of another index n₄. The region may be a hole.

The discontinuity may be uniform along the length of the waveguide. Thus the waveguide may be of uniform cross-section along its length.

The discontinuity may rotate along the whole or part of the length of the waveguide.

The waveguide may comprise a first longitudinal section in which the index variation from n₂ to n₁ has a first handedness (e.g. increasing with clockwise increase in azimuthal angle when viewed along a direction looking into an end of the section into which light is to be introduced, which is a left-handed variation from that viewpoint) and a second longitudinal section in which the index variation from n₂ to n₁ has a second, opposite, handedness (e.g. decreasing with clockwise increase in azimuthal angle when viewed from the same direction, which is a right-handed variation from that viewpoint). There may be a plurality of pairs of such oppositely handed sections. Equal lengths of such oppositely handed sections may be concatenated to form the waveguide. Concatenated equal-length sections may provide a quarter-period coupling length to achieve coupling between different modes of light.

The refractive index of the waveguide may vary radially. The refractive-index variation may result in concentric zones in the transverse cross-section of the fibre. The concentric zones may be annuli. The annuli may be of equal width, in which case the zones may form a Bragg zone plate. Alternatively, successive annuli may be of decreasing width, in which case the zones may form a Fresnel zone plate. (A Fresnel zone plate is a well-known optical device in which the outer radius of the nth annulus from the centre of the plate is given by rₙ=\sqrt{n}·r₁, where r₁ is the outer radius of the central area of the plate.)

There may be a plurality of radial discontinuities. The radial discontinuities may be at different azimuthal angles; for example, the discontinuities may be displaced by x degrees in successive zones at increasing radii, where x is selected from the following list: 180°, 90°, 72°, 60°, 45°, 30°. There may be a refractive-index variation resulting in concentric zones in the transverse cross-section of the fibre; the radial discontinuities may be in different zones.

According to a second aspect of the invention there is provided a method of transmitting light having a left- or right-handed non-zero orbital angular momentum, the method being characterised by introducing the light into a waveguide according the first aspect of the invention, the variation of refractive index with increasing azimuthal angle being such as to support propagation of light having the handedness of the transmitted light.

Thus, right-handed light may be introduced into a core having a refractive index that decreases as the azimuthal angle increases in a clockwise direction, viewed in the direction of propagation of the light. Alternatively, left-handed light may be introduced into a core having a refractive index that increases as the azimuthal angle increases in a clockwise direction, viewed in the direction of propagation of the light. The orbital angular momentum of the light may thus be preserved during propagation in the waveguide.

### BRIEF DESCRIPTION OF THE DRAWINGS

Embodiments of the invention will now be described by way of example only with reference to the accompanying drawings, of which:

FIGS. 1(a) and 1(b) are schematic cross-sections of two waveguides according to the invention, the fibres in (a) and (b) being of opposite handedness;

FIGS. 2(a) and 2(b) are schematic cross-sections of two further waveguides according to the invention, the fibres in (a) and (b) being of opposite handedness;

FIG. 3(a) is a schematic diagram of a chiral azimuthal GRIN fibre with light trajectory and FIG. 3(b) is its refractive-index profile;

FIG. 4(a) is a right-angled triangle for an “unwrapped” helix and FIG. 4(b) is a minimum-radius logarithmic spiral (quasi-helical) trajectory, featuring radial shifts at the refractive index discontinuity;

FIG. 5 is a schematic cross section of another waveguide according to the invention;

FIG. 6 is a schematic cross section of another waveguide according to the invention;

FIG. 7 is a schematic cross section of another waveguide according to the invention; and

FIG. 8 is a schematic cross section of another waveguide according to the invention.

### DETAILED DESCRIPTION OF THE INVENTION

An example embodiment of the invention is a microstructured fibre (MSF) design based on a chiral, refractive-index pattern in the fibre core that varies azimuthally, in contrast to the conventional radially varying refractive-index pattern. The fibre (FIG. 1) has a core 20 with azimuthally-varying local refractive indices, within a cladding 10 of uniform refractive index. The azimuthally (angularly) graded refractive index has a step discontinuity along one radial edge 50. The refractive index (RI) decreases from a high refractive index n₂ along the radial edge 50, to a lower refractive index n₁ as the azimuthal (polar) angle θ is increased. In this particular embodiment, the core 20 of the waveguide is contained within a concentric cladding 10 of higher refractive index n₃ (>n₁,n₂).

Light is guided within the fibre as a result of the chiral refractive index gradient. Light of the appropriate OAM follows a logarithmic helical trajectory (i.e. a vortex) with a reducing radius of rotation, whilst OAM remains conserved. Hence the light is confined by the azimuthally-varying index distribution, so that it is continually ‘focused’ into a tight vortex or helix, and cannot escape. However, light of the opposite handedness or chirality follows a helical trajectory with an ever increasing radius. Eventually, the radius of the helix is greater than that of the core, such that the light exits the core and is radiated away. Hence, light of this opposite handedness is not guided by the fibre, but radiates out.

The light bends to follow the refractive index gradient within the core 20, so that its trajectory follows a handed spiral as it propagates along the length of the fibre. The discontinuity along the radial edge 50 does not affect the propagation of the light, as there is an assumption of uniformity of azimuthal gradient across the discontinuity 50. Since the equation governing the light trajectory in a graded index (GRIN) medium tends to depend on the rate of change of refractive index, a perfect index discontinuity doesn't tend to affect the propagation (trajectory) of the light. The handedness of the trajectory spiral is uniquely determined by the handedness of the refractive index gradient. Hence, if light of an appropriate orbital angular momentum is launched into the fibre, guidance of the light will be supported. The OAM (and its handedness) will be conserved during propagation. Light of opposite handedness will not be guided and will radiate away.

The fibre is inherently handed in nature, which allows it to support propagation of light of only a single chirality.

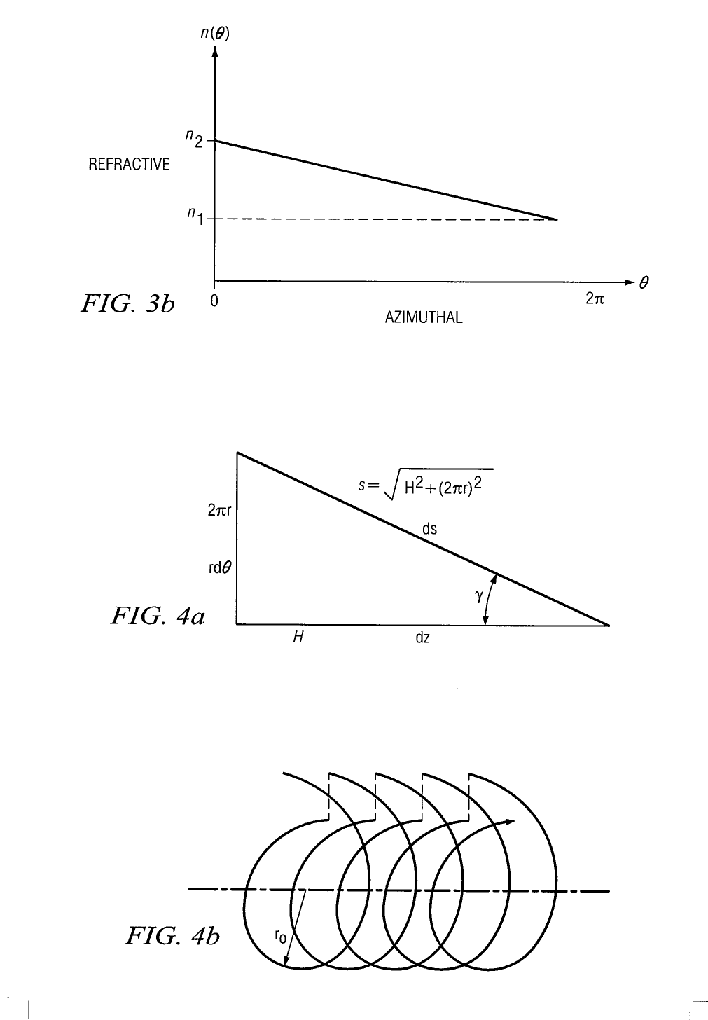

By way of explanation only and without limiting effect, we now explain our present understanding of the physics underlying the invention. In our analysis, we perform a variational calculus analysis of light propagation in a chiral fibre according to the invention. FIG. 3 shows a schematic diagram of the fibre and its refractive index profile as a function of azimuthal angle θ.

Propagation of light is analysed using Fermat's principle of least time. This not only has the advantage of reduced computational effort compared with beam propagation model analysis, but also yields a deeper insight into the waveguiding properties of our device. Equation (1) describes the trajectory s of a light ray in a medium with refractive index distribution n(x) as a function of Cartesian space x, which we transform into cylindrical coordinates (r, θ, z) for ease of analysis.

$$\frac{d }{d s} ( n ( \underline{x} ) \frac{d \underline{x}}{d s} ) = ∇ n ( \underline{x} ) \qquad ( 1 )$$

Equation (1) in cylindrical coordinates can be written as:

$$\{ \frac{d }{d s} ( n \frac{d r}{d s} ) - {nr ( \frac{d θ}{d s} )}^{2} \} \underline{{r}^{⋒}} + \{ n \frac{d r}{d s} \frac{d θ}{d s} + \frac{d }{d s} ( nr \frac{d θ}{d s} ) \} \underline{{θ}^{⋒}} + \{ \frac{d }{d s} [ n ( \frac{d z}{d s} ) ] \} \underline{{z}^{⋒}} = \frac{d n}{d r} \underline{{r}^{⋒}} + \frac{l}{r} \frac{d n}{d θ} \underline{{θ}^{⋒}} + \frac{d n}{d z} \underline{{z}^{⋒}} \qquad ( 2 )$$

### For the azimuthal GRIN geometry in which we are interested, we can assume that

$$\frac{d n}{d r} = \frac{d n}{d z} = 0.$$

In addition, we assume that light propagates along the fibre in an approximately helical trajectory. A helical trajectory lies on the surface of a cylinder, which when ‘unwrapped’ forms a right-angle triangle, as illustrated in FIG. 4(a). Given one turn of the helix of radius r, and length (i.e. pitch) H along the \hat{z}-direction (i.e. direction of propagation), then the length of the trajectory s is simply given by s²=H²+(2πr)² .

In addition, the helix can be characterised by the angle γ, such that

$$cos γ = \frac{H}{s} = \frac{d z}{d s} .$$

Using this feature of a helix, we can define the operator identity:

$$\frac{d }{d s} = cos γ \frac{d }{d z} \qquad ( 3 )$$

We also note that the quantity n\dot{θ}r² (where \dot{θ}=dθ/dz) is proportional to the OAM of the trajectory:

L= h̅k\dot{θ}r²=l h̅ (4)

and hence is both conserved and a constant of the motion, where k is the propagation constant of the light. We also note that the OAM is an integer multiple l of h̅. Rather than just assuming a constant radius helical trajectory, we can explore more possible trajectory solutions to the differential equations (2) by considering a logarithmic spiral (i.e. an approximately helical trajectory, but with varying radius). A logarithmic spiral is described by the expression dr=−βnrdθ, where the radius r changes with azimuthal angle θ, with β being the constant of the proportionality, equal to zero for a perfect helix. Applying the operator (3) to the equation for a logarithmic spiral, we yield:

$$\frac{d r}{d s} = - β nr θ cos γ = constant \qquad ( 5 )$$

Considering the radial direction of (2), we can write for an azimuthal GRIN fibre,

$$\frac{d }{d s} ( n \frac{d r}{d s} ) - {nr ( \frac{d θ}{d s} )}^{2} = 0 \qquad ( 6 )$$

Noting that

$$\frac{d n}{d s} = \frac{d n}{d θ} \frac{d θ}{d s} ,$$

using identity (3) where appropriate, and that (5) indicates that

$$\frac{{d}^{2} r}{d {s}^{2}} = 0 ,$$

equation (6) can be rearranged to yield dn(θ)=−dθ/β, which when integrated shows the azimuthal refractive index variation must be linear, n(θ)=n₂−θ/β, which is the same as for a spiral phase plate. Considering the azimuthal direction of (2), we have

$$n \frac{d r}{d s} \frac{d θ}{d s} + \frac{d }{d s} ( nr \frac{d θ}{d s} ) = \frac{l}{r} \frac{d n}{d θ} \qquad ( 7 )$$

For handedness preservation we only require one complete turn of the spiral trajectory along the fibre length Z, i.e. chiral guiding can be weak. This means that the refractive index difference denoting the discontinuity can tend to zero for arbitrary increasing length of fibre, i.e.

$$dn / n \to 0 \vert {lim}_{z \to ∞} .$$

### This is as required to be consistent with equation (7) being satisfied.

Considering equation (5), since β is a constant for a given azimuthal GRIN fibre, and for a given OAM of the light, n\dot{θ}r², the angle γ of the helix is determined by the constant and radius r. Equation (5) indicates that for an azimuthal GRIN variation n(θ)=n₂−θ/β, and for a positive (i.e. right-handed) OAM (determined by the sign of \dot{θ}), the radius of the trajectory will tend to decrease. In contrast, a left-handed (anti-clockwise) OAM will cause the radius of the trajectory to steadily increase until the trajectory exceeds the radius of the fibre, and the light will radiate out. Hence left-handed light is not guided by this azimuthal fibre, but is radiated away.

For the right-handed light, the radius will decrease with the light remaining within the fibre and hence being guided. However, the radius of the light can only decrease to a finite minimum value, due to the uncertainty principle. For a helical trajectory, the angular speed is given by \dot{θ}=2π/H, where H is the helix pitch. Since the OAM is a constant, the minimum radius is therefore given by

$${r}_{0} = \frac{l}{2 π} \sqrt{\frac{λ H}{n ( θ )}} ,$$

where l=1 (c.f. equation 4), and λ is the wavelength of the light. As can be seen, the helix radius depends on the azimuthal refractive index. Hence at the index discontinuity, the helix radius must also shift radially in order for OAM to be conserved, as indicated in FIG. 4(b) . This can be considered to be analogous to the optical Hall effect. A stable trajectory requires a 2π phase increment for each loop around the fibre, i.e. the trajectory length for each circuit must be an integer number of wavelengths. With regard to FIG. 4(a), this means that the trajectory length for one twist of the helix must be s=\sqrt{H²+(2πr₀)²}=Nλ, where N is an integer.

Substituting the expression for the minimum radius previously calculated, and considering only positive solutions, requires the helix pitch to be given by:

$$H = \frac{λ}{2 n} \{ \sqrt{1 + 4 {n}^{2} {N}^{2}} - 1 \} \qquad ( 8 )$$

It is of interest that the helical pitch is proportional to the period of a conventional first-order Bragg distributed grating.

The chiral counterpart of the fibre of FIG. 1(a) is shown in FIG. 1(b), with the opposite handedness.

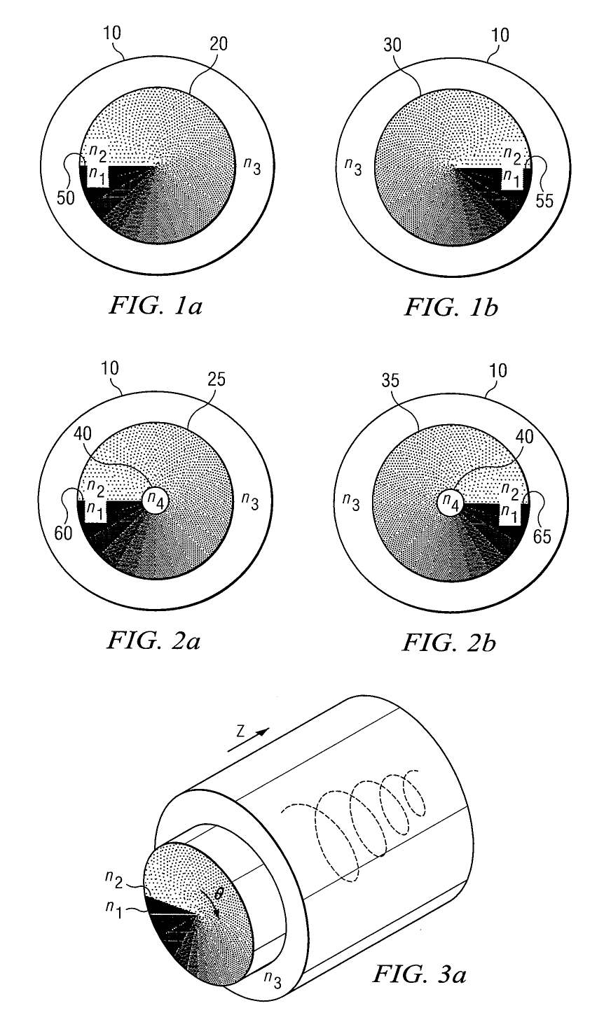

The phase singularity at the centre of the fibre geometry implies that there is zero amplitude of the light there (i.e. there is a singularity there, such that a finite amplitude of light cannot exist at the fibre centre). In some embodiments of the invention, there is a region (e.g. a concentric cylinder along the fibre length) of uniform refractive index consisting of either a material of refractive index n₄ (or equally, any of the other refractive indices n₁,n₂,n₃) or simply air (or a vacuum) similar to hollow-core fibre. Examples of such fibres are shown in FIG. 2. The fibres again have cores 25, 35 with azimuthally varying refractive indices within a uniform refractive-index cladding 10, this time with an additional uniform refractive index region 40 at the centre of the fibre. FIG. 2(b) is the oppositely-handed counterpart of the fibre of FIG. 2(a).

We also note that although our fibre has chiral properties, it does not necessarily have a twisted geometry itself (apart from the index gradient), i.e. the radial line discontinuity when extended along the fibre axis, remains straight to form a flat plane. Both FIGS. 1 and 2 show cross-sections of the OAM-conserving fibre. That same cross-section can be assumed to continue uniformly along the entire length of the fibre.

However, in another embodiment (not shown), the radial line discontinuity is twisted along the fibre axis, so that the cross-section rotates (either clockwise or anti-clockwise) with a certain pitch (or a chirped or aperiodic pitch) along the length of the fibre. The twist may be in the opposite sense to the index gradient.

In another embodiment, equal-length sections of left-handed and right-handed OAM-conserving fibre (twisted or untwisted) are concatenated to make an overall waveguide, and achieve additional novel functionality. In a variant of that embodiment, the equal-length sections are designed to be equivalent to a quarter-period coupling length (e.g. analogous to Bragg phase matching, or propagation mode matching), to provide coupling between different OAM modes (either of same handedness but different integer values of 1, or between two oppositely handed modes.)

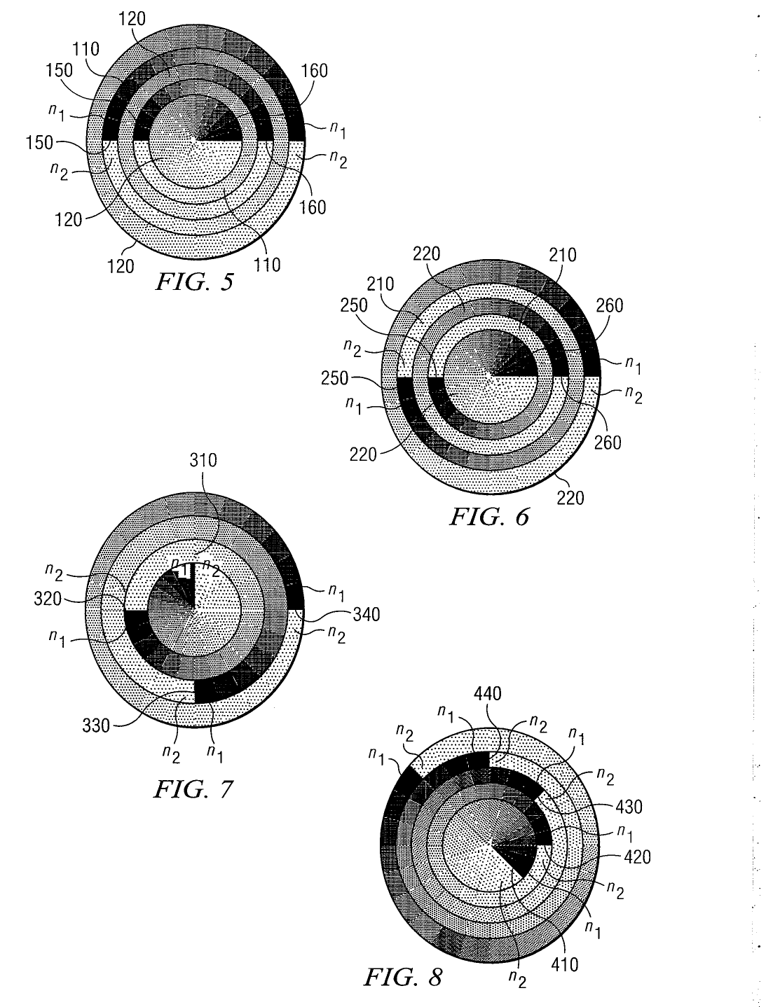

In the embodiment shown in FIG. 5, the azimuthal refractive index variation itself varies radially, forming concentric annuli 110, 120. In a first set of annuli 110, the azimuthal variation begins and ends at a first discontinuity 150 (which is itself discontinuous along a radius of the fibre). In a second set of annuli 120, the annuli of which are alternate with the annuli 110 of the first set at increasing radii, the azimuthal variation begins and ends at a second (discontinuous) discontinuity 160, which is azimuthally displaced by 180 degrees from the first discontinuity 150. The azimuthal variation within the annuli 110 of the first set is also of opposite handedness to the azimuthal variation within the annuli 120 of the second set.

The radii of the annuli 110, 120 are such that the annuli 110, 120 together form the pattern of a Fresnel zone plate. Fresnel zone plates are well known optical devices, which act as a type of lens, focusing light passing through the plate. The Fresnel structure of the FIG. 5 embodiment can itself act to guide light within the fibre; the azimuthal variation of refractive index can also assist in that guidance. However, because the handedness of the variation is different at different radii, other effects can be achieved. For example, higher-order transverse modes of light propagating in the fibre will tend to be larger in transverse cross-section than lower-order transverse modes. Different modes propagating in the fibre of FIG. 5 therefore impinge on different annuli 110, 120; as the handedness of the index variation is of an opposite sense in adjacent annuli 110, 120, modes of the same OAM will experience different loss, depending on the extent to which the net effect of the annuli 110, 120 by which they are affected tends to expel them from or confine them within the fibre. The fibre may thus act as a mode filter.

The fibre of the embodiment of FIG. 6 also comprises annular rings 210, 220, forming the pattern of a Fresnel zone plate. As in FIG. 5, the index discontinuity 250, 260 of each annulus 210, 220 is displaced by 180 degrees from that of its neighbour; however, in this case, the azimuthal variation is of the same handedness in each annulus 210, 220.

The fibres of the embodiments of FIGS. 7 and 8 also comprises annuli forming the pattern of a Fresnel zone plate. As in FIG. 6, the index variation is of the same handedness in each annulus. In FIG. 7, the index discontinuities 310, 320, 330, 340 in successive annuli, moving radially out from the centre are displaced in this embodiment by 90 degrees. In FIG. 8, index discontinuities 410, 420, 430, 440 in successive annuli are displaced by 45 degrees.

The ‘handedness’ dependency of waveguides according to the invention, examples of which are described above, may find applications in important emerging encryption techniques, such as physical layer data keys. In addition, our fibre can provide a means to flexibly guide OAM light in situations such as optical tweezers.

1. An optical waveguide comprising a core, characterised in that the core has a refractive index that includes a radial discontinuity and varies, with increasing azimuthal angle θ, from a first value n₂ at a first side of the discontinuity to a second value n₁ at a second side of the discontinuity.

2. A waveguide as claimed in claim 1, in which the variation in refractive index is monotonic with azimuthal angle, over 360 degrees, from the first value n₂ to the second value n₁.

3. A waveguide as claimed in claim 2, in which the variation is linear with azimuthal angle, over 360 degrees, from the first value n₂ to the second value n₁.

4. A waveguide as claimed in claim 1, further comprising a region at or substantially at the centre of the core into which the discontinuity does not extend.

5. A waveguide as claimed in claim 1, in which the discontinuity is uniform along the length of the waveguide.

6. A waveguide as claimed in claim 1, in which the discontinuity rotates along the whole or part of the length of the waveguide.

7. A waveguide as claimed in claim 1, in which the waveguide comprises a first longitudinal section in which the index variation from n₂ to n₁ has a first handedness and a second longitudinal section in which the index variation from n₂ to n₁ has a second, opposite, handedness.

8. A waveguide as claimed in claim 7, in which there are a plurality of pairs of the oppositely handed sections.

9. A waveguide as claimed in claim 8, in which equal lengths of the oppositely handed sections are concatenated to form the waveguide.

10. A waveguide as claimed in claim 1, in which the refractive index of the waveguide varies radially.

11. A waveguide as claimed in claim 10, in which the refractive-index variation results in concentric zones in the transverse cross-section of the fibre.

12. A waveguide as claimed in claim 11, in which the concentric zones are annuli.

13. A waveguide as claimed in claim 12, in which the annuli are of equal width and form a Bragg zone plate.

14. A waveguide as claimed in claim 12, in which successive annuli are of decreasing width, and the zones form a Fresnel zone plate.

15. A waveguide as claimed in claim 1, in which there is a plurality of radial discontinuities.

16. A waveguide as claimed in claim 15, in which the radial discontinuities are at different azimuthal angles.

17. A waveguide as claimed in claim 15, in which there is a refractive-index variation resulting in concentric zones in the transverse cross-section of the fibre and the radial discontinuities are in different zones.

18. A method of transmitting light having a left- or right-handed non-zero orbital angular momentum, the method being characterised by introducing the light into a waveguide as claimed in any preceding claim, the variation of refractive index with increasing azimuthal angle being such as to support propagation of light having the handedness of the transmitted light.
